(19) United States
(12) Patent Application Publication
(10) Pub. No.: US 2026/0138697 A1
(43) Pub. Date: May 21, 2026

(54) INFORMATION PROCESSING DEVICE, INFORMATION PROCESSING METHOD, AND A NON-TRANSITORY COMPUTER-READABLE STORAGE MEDIUM

(71) Applicant: HONDA MOTOR CO., LTD., Tokyo (JP)

(72) Inventor: Yuji Nishikawa, Tokyo (JP)

(73) Assignee: HONDA MOTOR CO., LTD., Tokyo (JP)

(21) Appl. No.: 19/451,189

(22) Filed: Jan. 16, 2026

Related U.S. Application Data
(63) Continuation of application No. PCT/JP2023/026638, filed on Jul. 20, 2023.

(51) Int. Cl. B62J 6/22; B62J 3/10; B62J 6/022; B62J 45/20

(52) U.S. Cl. CPC B62J 6/22; B62J 3/10; B62J 6/022; B62J 45/20

(57) ABSTRACT

An information processing device according to the present disclosure, detects that communication between a vehicle and a user terminal is established; and controls a notification unit included in the vehicle at a timing when the communication is established.

### CROSS-REFERENCE TO RELATED APPLICATION(S

This application is a continuation of International Patent Application No. PCT/JP2023/026638 filed on July 20, 2023, the entire disclosures of which are incorporated herein by reference.

### BACKGROUND OF THE INVENTION

### Field of the Invention

The present invention relates to an information processing device, an information processing method, and a non-transitory computer-readable storage medium.

### Description of the Related Art

Today, with the development of automobiles, anyone owns an automobile and uses it as a means for transportation to various places. In particular, in an Asian region, there are many users who use motorcycles, and it has been difficult to find a self-vehicle among a large number of vehicles arranged in a parking lot.

Japanese Patent Laid-Open No. 2003-300453 discloses a technique in which an automobile receiving a signal from a mobile phone turns on a light or sounds a horn, thereby confirming the position of the automobile.

However, in the technique described in Japanese Patent Laid-Open No. 2003-300453, a user needs to perform an operation via a mobile terminal when simply activating the light or the horn of the automobile, which causes inconvenience in operation.

### SUMMARY OF THE INVENTION

An object of the present invention is to provide an information processing device capable of checking a position of a parked vehicle without a user operation.

According to an aspect of the present invention, an information processing device comprising: a detection unit configured to detect that communication between a vehicle and a user terminal is established; and a control unit configured to control a notification unit included in the vehicle at a timing when the communication is established is provided.

Further features of the present invention will become apparent from the following description of exemplary embodiments (with reference to the attached drawings).

### BRIEF DESCRIPTION OF THE DRAWINGS

FIG. 1 is a right side view of a straddle type vehicle according to an embodiment of the present invention.

FIG. 2 is a front view of the straddle type vehicle of FIG. 1.

FIG. 3 is a block diagram illustrating an example of a configuration of a control device of the straddle type vehicle.

FIG. 4 is a diagram illustrating an outline of a control system according to an embodiment of the present invention.

FIG. 5 is a diagram for explaining a positional relationship in a case where logarithmic control is performed.

FIG. 6 is a block diagram illustrating an example of a hardware configuration of an information processing device.

FIG. 7 is a block diagram illustrating an example of a hardware configuration of a user terminal.

FIG. 8 is a flowchart illustrating an example of processing performed by the information processing device according to an embodiment.

### DESCRIPTION OF THE EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

In the drawings, arrows X, Y, and Z indicate directions orthogonal to one another, an X direction indicates a front-and-rear direction of a straddle type vehicle, a Y direction indicates a vehicle width direction (left-and-right direction) of the straddle type vehicle, and a Z direction indicates an up-and-down direction. The left and the right of the straddle type vehicle are the left and the right when viewed in an advancing direction. Hereinafter, the front or the rear of the straddle type vehicle in the front-and-rear direction may be simply referred to as the front or the rear. In addition, the inside or the outside of the straddle type vehicle in the vehicle width direction (left-and-right direction) may be simply referred to as the inside or the outside.

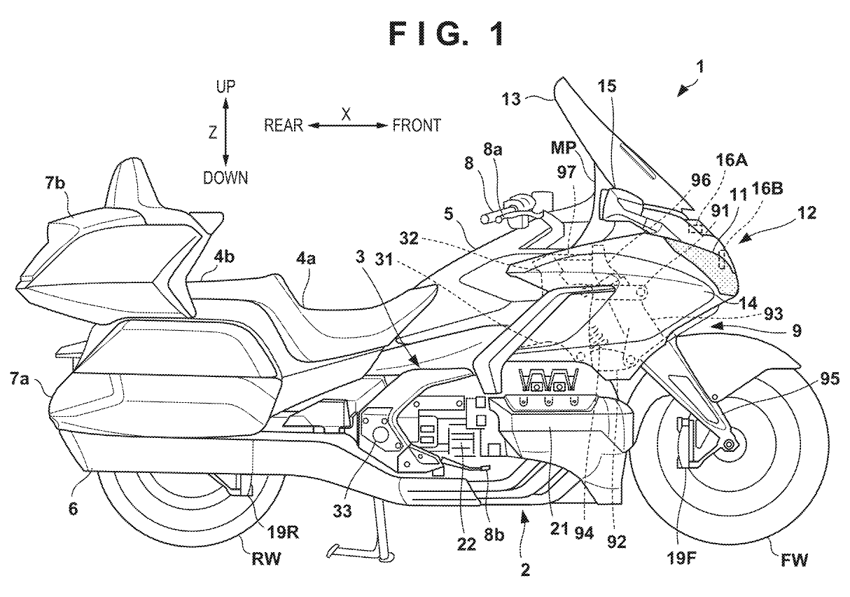

An information processing device according to the present embodiment is used in a control system that performs notification control of a vehicle according to a communication state between the vehicle and a user terminal, and provides a vehicle position check service accompanied by notification from a notification unit included in the vehicle. In the present embodiment, the description will be given assuming that the information processing device is an in-vehicle device mounted on the vehicle (straddle type vehicle 1) illustrated in FIG. 1, but is not particularly limited thereto as long as similar processing can be performed. For example, the information processing device may be a server device that communicates with the vehicle and the user terminal, and the user terminal may function as the information processing device. Here, the user terminal is assumed to be a terminal that can be operated by the user, such as a smartphone, a tablet terminal, or a wearable terminal, but may be, for example, a communication device having only a function of communicating with the vehicle.

### Outline of Straddle Type Vehicle

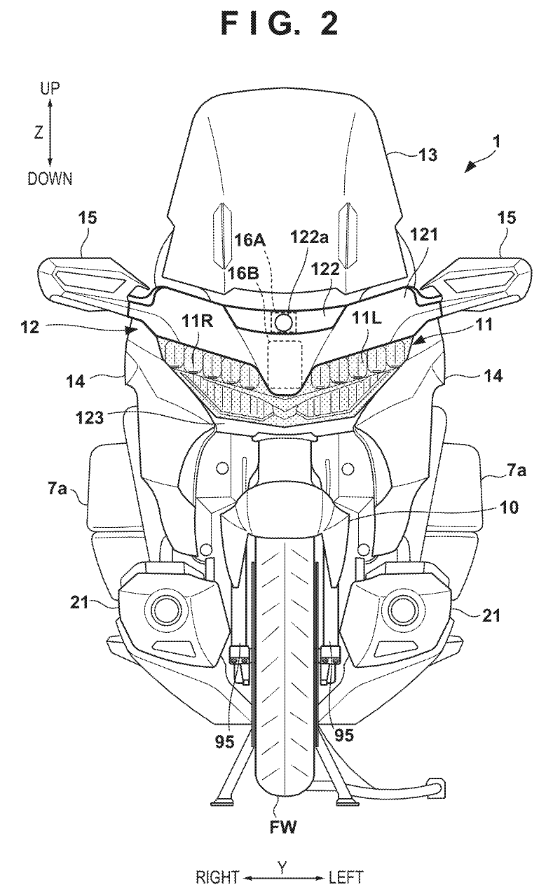

First, a vehicle in a control system according to the present embodiment will be described. FIG. 1 is a right side view of a straddle type vehicle 1 according to an embodiment of the present invention, and FIG. 2 is a front view of the straddle type vehicle 1.

The straddle type vehicle 1 is, for example, a tourer type motorcycle suitable for a long distance movement. However, the present invention is applicable to various straddle type vehicles including other types of motorcycles, and is also applicable to an electric vehicle using a motor as a drive source, in addition to a vehicle using an internal combustion engine as a drive source. Hereinafter, the straddle type vehicle 1 may be referred to as the vehicle 1.

The vehicle 1 includes a power unit 2 between a front wheel FW and a rear wheel RW. In the present embodiment, the power unit 2 includes a horizontally opposed six-cylinder engine 21 and a transmission 22. The driving force of the transmission 22 is transmitted to the rear wheel RW via a drive shaft (not illustrated) to rotate the rear wheel RW.

The power unit 2 is supported by a vehicle body frame 3. The vehicle body frame 3 includes a pair of left and right main frames 31 extending in the X direction. A fuel tank 5 and an air cleaner box (not illustrated) are disposed above the main frames 31. In front of the fuel tank 5, a meter panel MP including an electronic image display device or the like that displays various types of information to a rider is provided.

A head pipe 32 rotatably supporting a steering shaft (not illustrated) rotated by a handle 8 is provided at front end portions of the main frame 31. A pair of left and right pivot plates 33 are provided at rear end portions of the main frames 31. Lower end portions of the pivot plates 33 and the front end portions of the main frames 31 are connected with each other by a pair of left and right lower arms (not illustrated), and the power unit 2 is supported by the main frames 31 and the lower arms. A pair of left and right seat rails (not illustrated) extending rearward are also provided at the rear end portions of the main frames 31, and the seat rails support a seat 4a on which the rider is seated, a seat 4b on which a passenger is seated, a rear trunk 7b, and the like.

A front end portion of a rear swing arm (not illustrated) extending in the front-and-rear direction is swingably supported by the pivot plates 33. The rear swing arm is swingable in the up-and-down direction, and the rear wheel RW is supported at a rear end portion thereof. An exhaust muffler 6 that muffles exhaust of the engine 21 extends in the X direction on a lower lateral side of the rear wheel RW. Left and right saddle backs 7a are provided on upper lateral sides of the rear wheel RW.

A front suspension mechanism 9 that supports the front wheel FW is formed at the front end portions of the main frames 31. The front suspension mechanism 9 includes an upper link 91, a lower link 92, a fork support body 93, a cushion unit 94, and a pair of left and right front forks 95.

The upper link 91 and the lower link 92 are disposed at the front end portions of the main frames 31 so as to be vertically spaced apart from each other. Rear end portions of the upper link 91 and the lower link 92 are swingably coupled with support portions provided at the front end portions of the main frames 31. Front end portions of the upper link 91 and the lower link 92 are swingably coupled with the fork support body 93. The upper link 91 and the lower link 92 extend in the front-and-rear direction, and are also disposed substantially in parallel with each other.

The cushion unit 94 has a structure in which a shock absorber is inserted through a coil spring, and an upper end portion of the cushion unit 94 is swingably supported by the main frames 31. A lower end portion of the cushion unit 94 is swingably supported by the lower link 92.

The fork support body 93 has a tubular shape and is inclined rearward. A front end portion of the upper link 91 is rotatably coupled with an upper front portion of the fork support body 93. A front end portion of the lower link 92 is rotatably coupled with a lower rear portion of the fork support body 93.

A steering shaft 96 is supported by the fork support body 93 so as to be rotatable about its axis. The steering shaft 96 includes a shaft portion (not illustrated) inserted through the fork support body 93. A bridge (not illustrated) is provided at a lower end portion of the steering shaft 96, and the pair of left and right front forks 95 are supported by the bridge. The front wheel FW is rotatably supported by the front forks 95. An upper end portion of the steering shaft 96 is coupled with a steering shaft (not illustrated) to be rotated by the handle 8 via a link 97. The steering shaft 96 is rotated by steering the handle 8, and the front wheel FW is steered.

The vehicle 1 includes a brake device 19F that applies brake to the front wheel FW and a brake device 19R that applies brake to the rear wheel RW. The brake devices 19F and 19R are configured to be actuated by a rider’s operation on a brake lever 8a or a brake pedal 8b. The brake devices 19F and 19R are, for example, disc brakes. In a case where the brake devices 19F and 19R are not distinguished from each other, they will be collectively referred to as the brake device 19.

A headlight unit 11 that emits light ahead of the vehicle 1 is disposed in a front portion of the vehicle 1. The headlight unit 11 according to the present embodiment is a headlight unit of binocular type that includes a light irradiation unit 11R on a right side and a light irradiation unit 11L on a left side provided symmetrically in the left-and-right direction. However, a headlight unit of monocular or trinocular type or a headlight unit of binocular type provided asymmetrically in the left-and-right direction can also be adopted.

A front portion of the vehicle 1 is covered with a front cowl 12, and front side portions of the vehicle 1 are covered with a pair of left and right side cowls 14. A screen 13 is disposed above the front cowl 12. The screen 13 is a windshield that reduces wind pressure applied to the rider during traveling, and is made of, for example, a transparent resin member.

A pair of left and right side mirror units 15 are disposed on lateral sides of the front cowl 12. The side mirror units 15 support side mirrors (not illustrated) for the rider to visually recognize the rear side.

In the present embodiment, the front cowl 12 includes cowl members 121 to 123. The cowl member 121 extends in the Y direction to constitute a main body of the front cowl 12, and the cowl member 122 constitutes an upper portion of the cowl member 121. The cowl member 123 is disposed apart from the cowl member 121 in a downward direction.

An opening that exposes the headlight unit 11 is formed between the cowl member 121 and the cowl member 123 and between the pair of left and right side cowls 14. An upper edge of the opening is defined by the cowl member 121, a lower edge of the opening is defined by the cowl member 123, and left and right side edges of the opening are defined by the side cowls 14.

An imaging unit 16A and a radar 16B are disposed behind the front cowl 12 as detection devices that detect a situation ahead of the vehicle 1. The radar 16B is, for example, a millimeter wave radar. The imaging unit 16A includes an imaging element such as a CCD image sensor or a CMOS image sensor, and an optical system such as a lens, and captures an image ahead of the vehicle 1. The imaging unit 16A is disposed behind the cowl member 122, which constitutes an upper portion of the front cowl 12. In the cowl member 122, an opening 122a penetrating through the cowl member 122 is formed, and the imaging unit 16A captures an image ahead of the vehicle 1 through the opening 122a.

The radar 16B is disposed behind the cowl member 121. The presence of the cowl member 121 makes the presence of the detection unit 16 less noticeable when the vehicle 1 is viewed from the front, thereby making it possible to avoid the appearance of the vehicle 1 from being impaired. The cowl member 121 includes a material that allows transmission of electromagnetic waves, such as a resin.

The imaging unit 16A and the radar 16B are disposed at a center portion of the front cowl 12 in the Y direction when the vehicle is viewed from the front. By disposing the imaging unit 16A and the radar 16B at the center portion of the vehicle 1 in Y direction, a wider imaging range and a wider detection range can be obtained on the left and right ahead of the vehicle 1, and a situation ahead of the vehicle 1 can be detected without being overlooked. In addition, since one imaging unit 16A and one radar 16B can evenly monitor the left and right ahead of the vehicle 1, it is particularly advantageous in the configuration in which one imaging unit 16A and one radar 16B are provided rather than providing a plurality of imaging units 16A and a plurality of radars 16B.

### Control Device of Straddle Type Vehicle

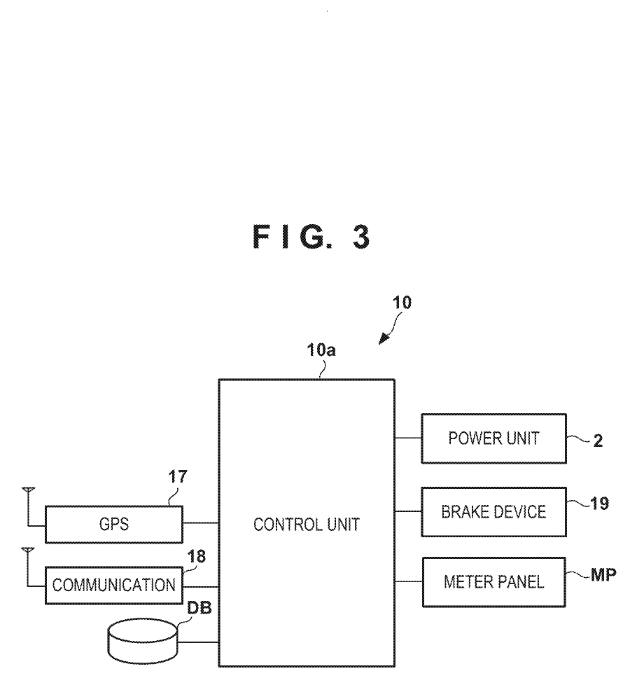

FIG. 3 is a block diagram of the control device 10 of the vehicle 1, and illustrates an example of a partial functional configuration including a configuration necessary in relation to the following description. The vehicle 1 includes a control unit (ECU) 10a. The control unit 10a includes a processor represented by a CPU, a storage device such as a semiconductor memory, an input/output interface or a communication interface with an external device, and the like. The storage device stores programs to be executed by the processor, data to be used by the processor for processing, and the like. The control unit 10a may include a plurality of sets of processors, storage devices, interfaces, and the like corresponding to the respective functions of the vehicle 1.

The control unit 10a is capable of controlling the actuators of the power unit 2 and the brake device 19. In the present embodiment, the control unit 10a controls them in a case where speed limitation processing to be described later is performed. The control unit 10a is also capable of controlling display on the meter panel MP. In the present embodiment, various warnings are displayed on the meter panel MP for the rider. In the present embodiment, the warning is actuated by displaying an image on the meter panel MP, but the warning may be actuated by turning on or blinking a lamp or by sound. The activation of the warning by sound may be controlled so that sound is output from a speaker provided in a helmet of the rider by wireless communication.

### Control System

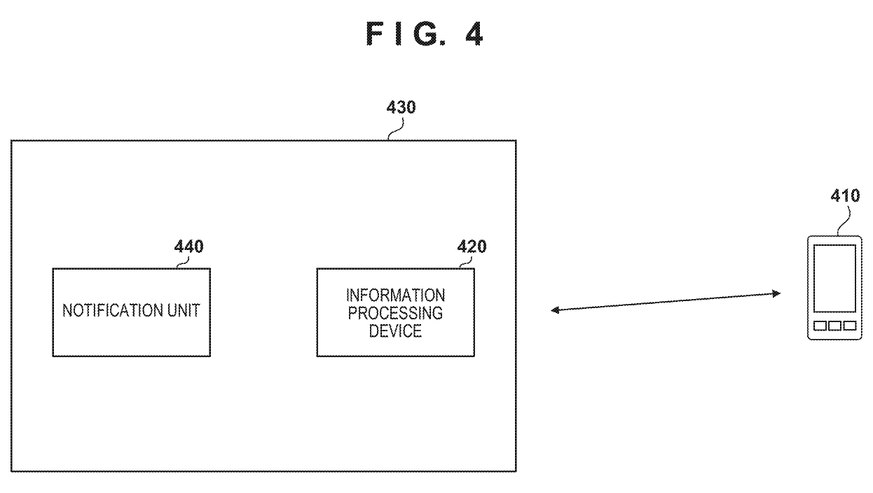

FIG. 4 is a diagram illustrating an example of a configuration of the control system according to the present embodiment. In a system 400, an information processing device 420 is communicably connected to a user terminal 410. The vehicle 430 may be the same as the vehicle 1 illustrated in FIG. 1. Furthermore, the user terminal 410 according to the present embodiment is a terminal device such as a smartphone, a tablet terminal, or a wearable terminal as described above.

In the control system according to the present embodiment, the user terminal 410 and the information processing device 420 included in the vehicle 430 detect a timing at which communication between the vehicle and the user is established. For example, when the user carrying the user terminal 410 walks toward the vehicle 430, and the above-described communication is established as the distance between the user terminal 410 and the vehicle 430 decreases, the information processing device 420 can detect that timing. The information processing device 420 controls a notification unit 440 included in the vehicle 430 at the timing when the communication is established.

The notification unit 440 notifies the user outside the vehicle 430. The notification unit 440 according to the present embodiment may be, for example, a light source included in the vehicle 430. In the present embodiment, it is possible to enable the user of the user terminal 410 to check the position of the self-vehicle by emitting light from the notification unit 440, which is a light source. The light source according to the present embodiment may be, for example, a headlight of the vehicle 430, a hazard lamp (emergency flashing indicator), a turn signal (direction indicator), or any other light provided on the vehicle 430. Furthermore, for example, the notification unit 440 may be an external light source different from that originally included in the vehicle 430.

Furthermore, for example, the notification unit 440 may be a sound output unit included in the vehicle 430. For example, when the vehicle 430 emits sound, it is possible to enable the user of the user terminal 410 to check the position of the self-vehicle. The sound output unit according to the present embodiment may be, for example, an alarming device (horn) provided in the vehicle 430, a speaker that outputs sound, or the like. The speaker may be an in-vehicle device of the vehicle 430 or may be an external device that is not an in-vehicle device of the vehicle 430.

In addition, the duration of each notification by the notification unit 440 is not particularly limited, but may be 15 seconds or the like here. Furthermore, in a case where the notification by the light source and the notification by the sound output unit are simultaneously performed, the notification durations thereof may be different from each other. For example, the notification by the light source may be performed until the vehicle is unlocked (until an operation for turning off the notification is performed), and the notification by the sound output unit may be performed for 15 seconds.

Furthermore, the notification by the notification unit 440 may be overlooked by the user if the notification is performed only once at the time when the communication is established. From such a viewpoint, the notification unit 440 may perform notifications at predetermined intervals (which can be set arbitrarily). The notification unit 440 may perform a notification, for example, every 15 seconds, every 20 seconds, every 30 seconds, or every 45 seconds. Furthermore, the number of times the notification unit 440 performs a notification may be set in advance to a predetermined number of times. These settings may be set by the user via an application on the user terminal 410 (or on the in-vehicle device of the vehicle 430), or initial settings may be set. In this manner, by performing the notification control at predetermined intervals or a predetermined number of times, it is possible to reduce the possibility that the user overlooks the notification.

In addition, there is a possibility that the notification by the sound output unit becomes noise for surrounding people, and therefore, the duration of each notification may be set to a predetermined time or less. For example, the duration of each notification by the sound output unit may be set to a predetermined time or less (e.g., 1 second). Furthermore, for example, the duration of each notification by the sound output unit may be shorter than the duration of each notification by the light source.

Note that, in the present embodiment, establishment of communication between the information processing device 420 included in the vehicle 430 and the user terminal 410 is referred to as “establishment of communication between the vehicle and the user terminal”. However, the “establishment of communication between the vehicle and the user terminal” may also refer to establishment of communication between an in-vehicle device different from the information processing device 420 and the user terminal 410. Hereinafter, when “communication” is simply referred to, it refers to communication between the vehicle 430 and the user terminal 410.

### Hardware Configuration

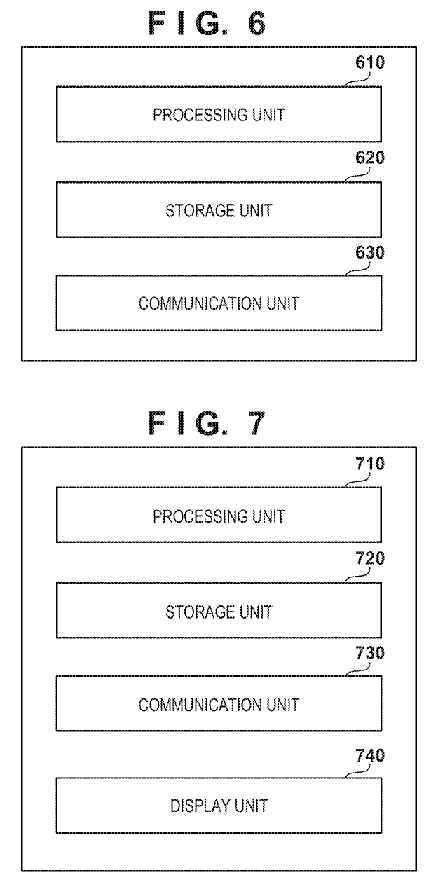

FIG. 6 is a block diagram illustrating an example of a hardware configuration of the information processing device 420. The information processing device 420 includes a processing unit 610, a storage unit 620, and a communication unit 630. The processing unit 610 is a central processing unit such as a CPU, and executes a program stored in the storage unit 620 to perform each type of processing. The storage unit 620 is a storage device such as a RAM, a ROM, or a hard disk. The program stored in the storage unit 620 includes an application program for a vehicle position check service by the control system according to the present embodiment. Such an application program may be downloaded from a server, or may be distributed in a storage medium such as a CD-ROM.

Furthermore, the storage unit 620 stores information about the associated user terminal 410, which can be referred to when communication is established. Furthermore, the storage unit 620 can store information regarding the content of notification control by the notification unit 440, such as what kind of notification control is to be performed when communication is established.

The communication unit 630 includes a wireless communication interface capable of communicating with the user terminal 410. In the present embodiment, the information processing device 420 (the communication unit 630) and the user terminal 410 communicate with each other as described above, but an in-vehicle device of the vehicle 430 different from the information processing device 420 may communicate with the user terminal 410, and the information processing device 420 may control notification by the notification unit 440 according to the communication state.

FIG. 7 is a block diagram illustrating an example of a hardware configuration of the user terminal 410. The user terminal 410 includes a processing unit 710, a storage unit 720, a communication unit 730, and a display unit 740. The processing unit 710 is a central processing unit such as a CPU, and executes a program stored in the storage unit 720 to perform each type of processing. The storage unit 720 is a storage device such as a RAM, a ROM, or a hard disk. The program stored in the storage unit 720 includes an application program for a vehicle position check service by the control system according to the present embodiment. Such an application program may be downloaded from a server, or may be distributed in a storage medium such as a CD-ROM.

Furthermore, the storage unit 720 may store position information of the vehicle 430 and map data, which may be referred to when the user confirms the position of the vehicle 430 on the application. The position information of the vehicle 430 may be acquired from a GPS sensor or the like provided in the vehicle 430, or may be position information of the user terminal 410 when the ignition of the vehicle 430 is turned off.

The communication unit 730 includes a wireless communication interface capable of communicating with the vehicle 430 (the information processing device 420). The display unit 740 is, for example, a liquid crystal display or a touch panel, and can display an application screen including rough position information of the vehicle 430, a notification instruction to the vehicle 430, or the like. In addition, the display unit 740 can acquire a user's input based on a user's contact with the touch panel or the like.

### Information Processing

Next, processing of detecting that communication between the vehicle and the user terminal is established, which is performed by the information processing device 420, will be described. In the present embodiment, the information processing device 420 is a communication unit that performs communication using Bluetooth (registered trademark), and establishes connection with the user terminal 410. Note that this communication method is an example, and the information processing device 420 may perform communication using another communication method for performing short-range wireless communication, such as ad-hoc communication such as UWB or ZigBee (registered trademark).

Referring to a communication state based on short-range wireless communication such as Bluetooth, the information processing device 420 detects whether communication with the user terminal 410 registered in advance is established. For example, the information processing device 420 can monitor whether connection with the user terminal 410 is established, and control subsequent notification processing when communication is established, for example, as the user carrying the user terminal 410 approaches.

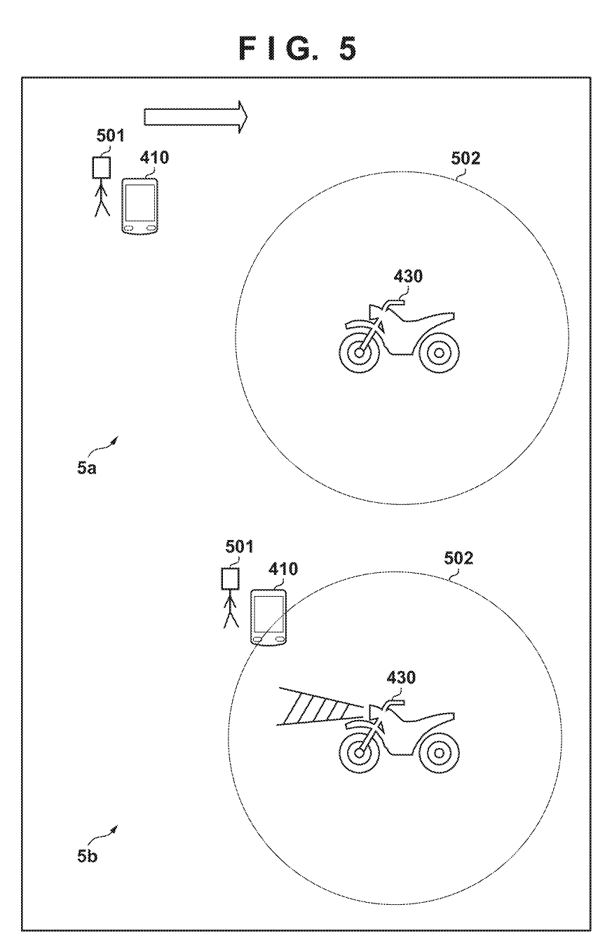

FIG. 5 is a diagram for explaining a case where the information processing device 420 according to the present embodiment detects establishment of communication between the vehicle 430 and the user terminal 410. In FIG. 5, an area 502 is illustrated, assuming that communication is established with the vehicle 430 in a case where the user terminal 410 is present in the area 502. In FIG. 5(a), a user 501 having the user terminal 410 is walking toward the vehicle 430, but communication is not established, and the notification unit of the vehicle 430 is not controlled. In FIG. 5(b), communication is established because the user 501 has moved into the area 502, and the notification unit of the vehicle 430 is activated by the information processing device 420. Such processing enables the user to check the position of the parked vehicle without operating the terminal device.

In the present embodiment, the information processing device 420 performs the communication processing, for example, via an application operating on the user terminal 410. For example, this application may perform communication processing while running on the background of the user terminal 410, or may perform communication processing while running in the foreground. This processing can be generally performed in a similar manner to the processing when short-range wireless communication is performed by the application, and the detailed description thereof will be omitted.

Note that, in a case where the information processing device 420 is kept in a standby state at all times to detect whether communication is established, the battery may be consumed more than necessary. From such a viewpoint, the information processing device 420 may detect whether communication is established while a predetermined time condition is satisfied. That is, the information processing device 420 according to the present embodiment can be in a standby state in which it is determined whether communication is established while the predetermined time condition is satisfied, and can be in a sleep mode in which it is not determined during the other period.

For example, in a case where the vehicle is temporarily stopped for an errand or the like, the user may finish the errand and return to the vehicle within a short period of time. From such a viewpoint, the information processing device 420 may detect that communication is established for a predetermined period after the ignition of the vehicle 430 is turned off. The predetermined period can be set as desired by the user, and may be, for example, 2 hours, 3 hours, or 4 hours. In this manner, the predetermined time condition may be within the predetermined period based on the time when the ignition of the vehicle 420 is turned off.

Furthermore, for example, the time to get on the vehicle may be fixed to some extent, such as the time to go to work or the time to return home. From such a viewpoint, the information processing device 420 may detect that communication is established in a predetermined time zone. The predetermined time zone can be set as desired by the user, and may be, for example, 6 to 9 o'clock or 17 to 19 o'clock. In this manner, the predetermined time condition may be the predetermined time zone.

Furthermore, for example, in a case where it is determined that the battery is deteriorated, the information processing device 420 may not determine whether communication is established (a sleep mode) regardless of the other conditions in order to avoid battery consumption. The conditions for determining that the battery is deteriorated can be set using desired conditions. For example, the information processing device 420 may determine that the battery is deteriorated when a voltage of the battery measured by a known voltage measurement technique using a sensor is lower than a predetermined value (e.g., 12.5 V).

Note that, although it has been described that the notification unit is controlled at a timing when communication is established in the present embodiment, the timing when the notification is performed by the control may be the same as or may not be the same as the timing when communication is established. For example, the information processing device 420 may perform a notification after a predetermined time (e.g., after 5 seconds) from the timing when communication is established.

Furthermore, although it has been described that the user is notified by the notification unit 440 included in the vehicle 430 in the present embodiment, the notification unit 440 may notify the user by controlling the user terminal 410. That is, the notification unit 440 may perform a notification by controlling the user terminal 410 at a timing when communication is established. In that case, the notification unit 440 may vibrate the user terminal 410, may cause the user terminal 410 to output sound, may cause the user terminal 410 to display a message, or may perform control using a combination of two or more thereof.

Furthermore, the notification unit 440 may perform control to notify the content according to the distance between the vehicle 430 and the user terminal 410. For example, the notification unit 440 may perform control such that the volume increases and the voice output from the user terminal 410 increases as the distance between the vehicle 430 and the user terminal 410 decreases. Here, the distance between the vehicle 430 and the user terminal 410 may be evaluated according to the strength of communication, or may be calculated based on the position information.

Note that, in the present embodiment, an example has been described in which the notification unit included in the vehicle is automatically controlled without any operation of the terminal by the user as communication is established. In addition, the notification unit 440 may perform an additional notification in accordance with a user operation via the user terminal 410. For example, as communication is established, an application screen for receiving a user input may be opened on the information processing device 420, and an input to be notified again may be accepted by the user terminal 410.

### Flowchart

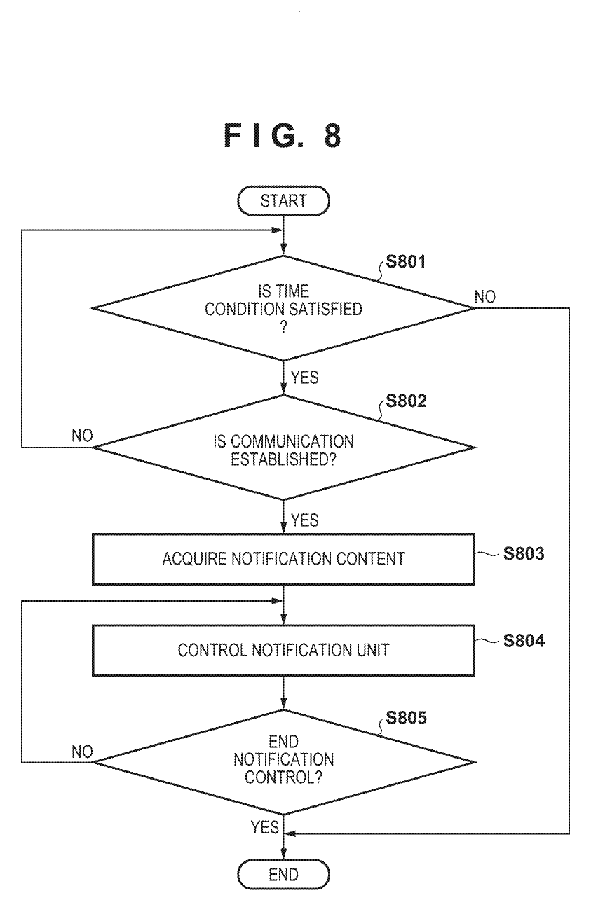

FIG. 8 is a flowchart illustrating an example of processing performed by the information processing device 410 in the control system according to the present embodiment. Note that the following description will be given on the assumption that the processing according to FIG. 8 is started by the processing unit 610 of the information processing device 420 when the ignition of the vehicle 430 is turned off.

In S801, the information processing device 420 determines whether a predetermined time condition, which is a condition for determining whether communication between the vehicle 430 and the user terminal 410 is established, is satisfied. When the predetermined time condition is satisfied, the processing proceeds to S802, and when the predetermined time condition is not satisfied, the processing of FIG. 8 ends.

In S802, the information processing device 420 determines whether communication between the vehicle 430 according to the present embodiment and the user terminal is established. When communication is established, the processing proceeds to S803, and when communication is not established, the processing returns to S801.

In S803, the information processing device 420 acquires the content of notification control to be performed by the notification unit. Here, the content of the predetermined notification control is stored in the storage unit 620, and the content is acquired. However, for example, in a case where notification control is performed based on the content according to the distance between the vehicle 430 and the user terminal 410, the notification content may be set in S803.

In S804, the information processing device 420 controls the notification unit 440 based on the content of notification control acquired in S803. In S805, the information processing device 420 determines whether to end the notification control. For example, in a case where the notification is set to be performed a predetermined number of times, the information processing device 420 determines whether the notification based on the control instruction in S804 has been performed a predetermined number of times. When it is determined to end the notification control, the processing of FIG. 8 ends, and when it is not determined to end the notification control, the processing returns to S804. Note that, here, in a case where the notification is set to be performed at predetermined intervals, the processing returns to S804 when the predetermined interval has elapsed.

According to such a configuration, it is possible to detect that communication between the vehicle and the user terminal is established and control the notification unit included in the vehicle at the timing when the communication is established. Therefore, it is possible to provide an information processing device capable of checking a position of a parked vehicle without a user operation.

### Summary of Embodiment

The above-described embodiment discloses at least the following information processing device, information processing method, and program.

1. An information processing device (for example, 420) according to the above embodiment comprises:

a detection unit (for example, 610) configured to detect that communication between a vehicle and a user terminal is established; and

a control unit (for example, 610) configured to control a notification unit included in the vehicle at a timing when the communication is established.

According to this embodiment, it is possible to check the position of the parked vehicle without a user operation.

2. In the information processing device according to the above embodiment, the notification unit is a light source included in the vehicle.

According to this embodiment, it is possible to enable the user to check the position of the vehicle using a light source of the vehicle.

3. In the information processing device according to the above embodiment, the light source is a headlight of the vehicle.

According to this embodiment, it is possible to enable the user to check the position of the vehicle using a headlight of the vehicle.

4. In the information processing device according to the above embodiment, the light source is a hazard lamp of the vehicle.

According to this embodiment, it is possible to enable the user to check the position of the vehicle using a hazard lamp of the vehicle.

5. In the information processing device according to the above embodiment, the notification unit is a sound output unit included in the vehicle.

According to this embodiment, it is possible to enable the user to check the position of the vehicle through sound emitted by the vehicle.

6. In the information processing device according to the above embodiment, the detection unit detects whether the communication is established when a predetermined time condition is satisfied.

According to this embodiment, it is possible to reduce battery consumption by restricting the detection of communication based on time.

7. In the information processing device according to the above embodiment, the predetermined time condition is within a predetermined period from a time when ignition of the vehicle is turned off.

According to this embodiment, it is possible to put detection of communication into a sleep mode in a time zone in which the vehicle is less likely to be used.

8. In the information processing device according to the above embodiment, the predetermined time condition is a predetermined time zone.

According to this embodiment, it is possible to put detection of communication into a sleep mode in a time zone in which the vehicle is less likely to be used.

9. The information processing device according to the above embodiment, further comprising:

a determination unit configured to determine whether a battery of the vehicle is deteriorated,

wherein when it is determined that the battery is deteriorated, the detection unit does not detect whether the communication is established.

According to this embodiment, it is possible to put detection of communication into a sleep mode when the battery is deteriorated.

10. In the information processing device according to the above embodiment, the control unit performs control so that the notification unit performs notification at predetermined intervals.

According to this embodiment, it is possible to reduce the possibility that the user overlooks the notification by periodically executing the notification control.

11. In the information processing device according to the above embodiment, the control unit performs control so that the notification unit performs notification a predetermined number of times.

According to this embodiment, it is possible to reduce the possibility that the user overlooks the notification by executing the notification control a plurality of times.

12. An information processing method according to the above embodiment comprises:

detecting that communication between a vehicle and a user terminal is established; and

controlling a notification unit included in the vehicle at a timing when the communication is established.

According to this embodiment, it is possible to check the position of the parked vehicle without a user operation.

13. A program according to the above embodiment, causes an information processing device to function as:

a detection unit configured to detect that communication between a vehicle and a user terminal is established; and

a control unit configured to control a notification unit included in the vehicle at a timing when the communication is established.

According to this embodiment, it is possible to check the position of the parked vehicle without a user operation.

14. A non-transitory computer-readable storage medium according to the above embodiment, stores a program, that causes an information processing device to function as:

a detection unit configured to detect that communication between a vehicle and a user terminal is established; and

a control unit configured to control a notification unit included in the vehicle at a timing when the communication is established

According to this embodiment, it is possible to check the position of the parked vehicle without a user operation.

Although the embodiment of the invention has been described above,

The invention is not limited to the foregoing embodiments, and various variations/changes are possible within the spirit of the invention.

What is claimed is:

1. An information processing device comprising:
a detection unit configured to detect that communication between a vehicle and a user terminal is established; and
a control unit configured to control a notification unit included in the vehicle at a timing when the communication is established.

2. The information processing device according to claim 1, wherein the notification unit is a light source included in the vehicle.

3. The information processing device according to claim 2, wherein the light source is a headlight of the vehicle.

4. The information processing device according to claim 2, wherein the light source is a hazard lamp of the vehicle.

5. The information processing device according to claim 1, wherein the notification unit is a sound output unit included in the vehicle.

6. The information processing device according to claim 1, wherein the detection unit detects whether the communication is established when a predetermined time condition is satisfied.

7. The information processing device according to claim 6, wherein the predetermined time condition is within a predetermined period from a time when ignition of the vehicle is turned off.

8. The information processing device according to claim 6, wherein the predetermined time condition is a predetermined time zone.

9. The information processing device according to claim 6, further comprising:
a determination unit configured to determine whether a battery of the vehicle is deteriorated,
wherein when it is determined that the battery is deteriorated, the detection unit does not detect whether the communication is established.

10. The information processing device according to claim 1, wherein the control unit performs control so that the notification unit performs notification at predetermined intervals.

11. The information processing device according to claim 1, wherein the control unit performs control so that the notification unit performs notification a predetermined number of times.

12. An information processing method comprising:
detecting that communication between a vehicle and a user terminal is established; and
controlling a notification unit included in the vehicle at a timing when the communication is established.

13. A non-transitory computer-readable storage medium storing a program, that causes an information processing device to function as:
a detection unit configured to detect that communication between a vehicle and a user terminal is established; and
a control unit configured to control a notification unit included in the vehicle at a timing when the communication is established
.
